(19) United States
(12) Patent Application Publication
(10) Pub. No.: US 2013/0300421 A1
(43) Pub. Date: Nov. 14, 2013

(54) SYSTEM FOR DETECTING UNDERWATER GEOLOGICAL FORMATIONS IN PARTICULAR FOR THE LOCALIZATION OF HYDROCARBON FORMULATIONS

(71) Applicants: Paolo Dell'Aversana, Milano (IT); Michele Filippini, Preganziol (TV) (IT); Matteo Pasquini, Venezia (IT)

(72) Inventors: Paolo Dell'Aversana, Milano (IT); Michele Filippini, Preganziol (TV) (IT); Matteo Pasquini, Venezia (IT)

(73) Assignee: Eni S.P.A., Rome (IT)

(21) Appl. No.: 13/995,408

(22) PCT Filed: Dec. 16, 2011
(86) PCT No.: PCT/EP2011/073137

§ 371 Date: Jul. 19, 2013

(30) Foreign Application Priority Data
Dec. 22, 2010 (IT) MI2010A002355

(51) Int. Cl. G01V 3/15

(52) U.S. Cl. CPC G01V 3/15
USPC 324/365

(57) ABSTRACT

The present invention relates to a system (100) for detecting underwater geological formations, in particular for the localization of reservoirs of hydrocarbons such as oil and/or natural gas, comprising an electromagnetic transmission device (10) which can be moved within an area to be surveyed (101) through sea surface tow means (14) along an advance direction (A) and at least one electromagnetic reception device (20) positioned in the area to be surveyed (101) and characterized in that the electromagnetic reception device (20) comprises at least one flat structure (20a) consisting of a plurality of linear elements (21) constrained to each other according to a bidimensional lattice configuration and a plurality of reception electrodes (22, 22a), wherein each reception electrode (22, 22a), of the plurality of reception electrodes (22, 22a) is constrained in correspondence with an intersection between pairs of said linear elements (21).

The present invention relates to a system for detecting underwater geological formations, in particular for the localization of reservoirs of hydrocarbons such as oil and/or natural gas.

In the field of the exploration of underwater subsoil, the application of indirect survey methods is well known. They are aimed at reconstructing the morphology and nature of seabeds, the geometry of sediments and the underlying rocks, in addition to the localization of reservoirs in particular of hydrocarbons present under the sea bottom.

Over the years, the indirect survey method based on the response provided by the subsoil to an electromagnetic excitation has proved to be particularly suitable.

For this purpose, an electromagnetic field is generated and the electromagnetic response of the subsoil is detected, whose intensity and phase depend on the electric conductivity of the geological formations encountered along the propagation route.

The electric resistivity (inverse of conductivity) of the soil depends on various factors such as the degree of saturation, salinity of the water present in the geological formations, the mineralogical composition and so forth. In particular, a formation containing hydrocarbons has a greater resistivity with respect to the same formation containing seawater.

The electromagnetic survey method which is at present most widely used, also called marine controlled source electromagnetic method (CSEM), consists in recognizing, through the modifications undergone by the electromagnetic field emitted, the areas with a high resistivity of the underwater subsoil.

This technique has led to an improvement in the reliability of surveying and characterizing hydrocarbon reservoirs also in deep water, determining the resistivity of formations below the seabed and indirectly indicating the presence of hydrocarbons.

For implementing electromagnetic survey methods, detection systems of underwater geological formations comprising a transmission device and an electromagnetic reception device, are known.

More specifically, the electromagnetic transmission device generally comprises an electric dipole towed to a certain depth along a certain advance direction, which is used for exciting a low-frequency electromagnetic signal, ranging for example from 0.05 Hz to 1 Hz.

The classical implementation of the electromagnetic transmission device used in survey systems of underwater geological formations envisages entrainment on the part of the boat of an electric cable through which a high alternating current runs, at a depth generally equal to about 50 m from the sea bottom.

The cable through which the alternating current runs, generates an electromagnetic field which propagates through the sea water and subsoil down to a depth of a few kilometers.

The detection of the response of the subsoil to the electromagnetic excitation occurs through a plurality of sensors placed in contact with the sea bottom and spatially positioned along the advance direction of the electromagnetic transmission device, which form the electromagnetic reception device of currently known survey systems.

In particular, the sensors are composed of single stations each comprising two or more orthogonal electric dipoles and two or more orthogonal magnetometers, generally positioned in line at the sea bottom and recoverable after the survey through the activation of floating means.

From the detection of the electromagnetic response of the subsoil, a resistivity discontinuity can be determined in the trajectory of the electromagnetic field, therefore allowing a higher resistivity area to be more or less localized, index of the possible presence of a hydrocarbon formation.

The detection systems of underwater geological formations currently known, however, provide excessively ambiguous information and with a low redundancy, consequently not allowing stable and robust models to be obtained, i.e. capable of providing a univocal solution with respect to the localization of the formations.

Following the approximation provided by the detection systems of underwater geological formations currently known, it is only possible to obtain measurements characterized by an excessively high imprecision for completely reliable use in mineral applications.

In particular, the approximation of the measurements can, on the one hand, be attributed to the necessity of the electromagnetic transmission device used in the known detection systems of always being in movement. This circumstance does not allow to effect surveys at different frequencies relating to the same position, which would allow more data to be obtained on the particular position.

Furthermore, the continuous movement of the electromagnetic source necessitates its distancing from the sea bottom, which consequently leads to a partial dispersion of the energy irradiated before it penetrates the subsoil. A lesser penetration depth of the signal irradiated is therefore obtained.

In addition, the use of a single hertzian dipole as electromagnetic transmission device prevents the generation of polarized electromagnetic signals according to a different direction to the navigation direction.

The electromagnetic transmission devices currently used in detection systems of underwater geological formations therefore only partially allow, i.e. with significant limits of precision and univocality, information to be obtained with respect to the position and three-dimensional geometry and fluid content of the hydrocarbon formations present in the underwater subsoil.

The electromagnetic reception devices used in known survey systems also provide limits to the resolution and accuracy of the surveys effected.

In particular, the stations with dipoles and magnetometers currently used are not capable of providing the complete tensor of the electromagnetic field as they can only effect measurements along two directions. With these stations it is also impossible to detect the horizontal gradient of the electric field.

Both of these measurements, however, are fundamental for obtaining a precise localization and determination of the geometry of a hydrocarbon formation and saturation level of the hydrocarbons themselves.

Furthermore, as, after a survey campaign, the electromagnetic reception devices currently used in survey systems of underwater geological formations must be recovered in order to have access to the measurements effected, if the evolution with time of the same reservoir is to be monitored, they must be accurately repositioned in correspondence with the same points from which the first survey was effected.

These electromagnetic reception devices, however, do not allow a piloted positioning at the sea bottom, thus making an exact repositioning impossible.

In conclusion, with the detection systems of underwater geological formations currently known, it is not possible to effect, with the necessary accuracy, surveys over a period of time, also called time-lapse surveys, of hydrocarbon formations.

An objective of the present invention is to overcome the drawbacks mentioned above and in particular to conceive a detection system of underwater geological formations capable of providing a combination of measurements which are sufficiently accurate for both identifying and characterizing in the three dimensions the geometry of a hydrocarbon formation, and also for determining the saturation level of the hydrocarbons themselves.

Another objective of the present invention is to provide a detection system of underwater geological formations which allows the evolution of a hydrocarbon formation to be monitored with time through time-lapse surveys.

A further objective of the present invention is to provide a detection system of underwater geological formations capable of providing measurements of both the electromagnetic tensor and the gradient of the electric field supplied in response from the subsoil.

These and other objectives according to the present invention are achieved by providing a detection system of underwater geological formations as specified in claim 1.

Further characteristics of the detection system of underwater geological formations are object of the dependent claims.

The characteristics and advantages of a detection system of underwater geological formations according to the present invention will appear more evident from the following illustrative and non-limiting description, referring to the enclosed schematic drawings, in which:

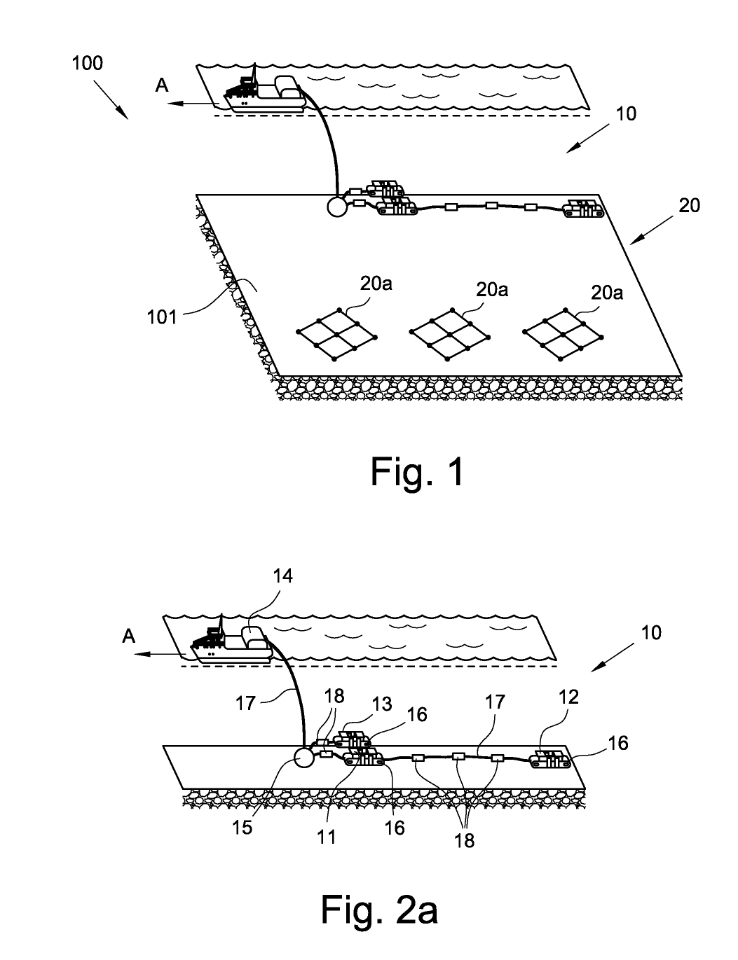

FIG. 1 is a schematic view of a preferred embodiment of a detection system of underwater geological formations according to the present invention;

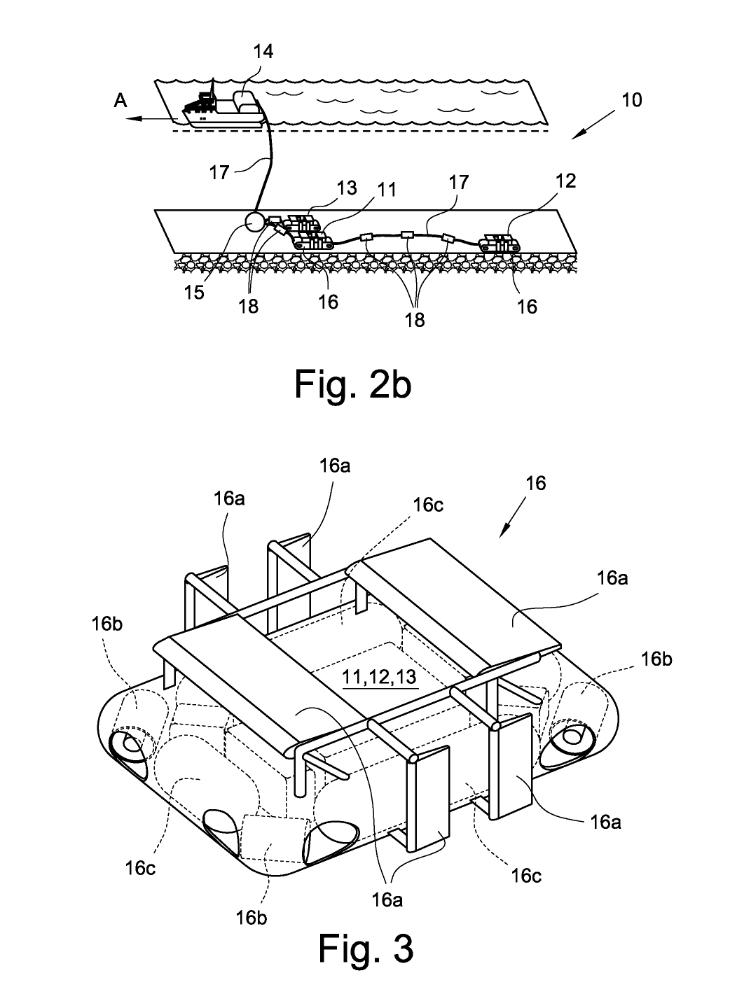

FIGS. 2a-2b are schematic perspective views of an electromagnetic transmission device in a dynamic and static survey configuration, used in the detection system of underwater geological formations of FIG. 1;

FIG. 3 is a perspective view of a piloting means used in the electromagnetic transmission device of FIG. 2;

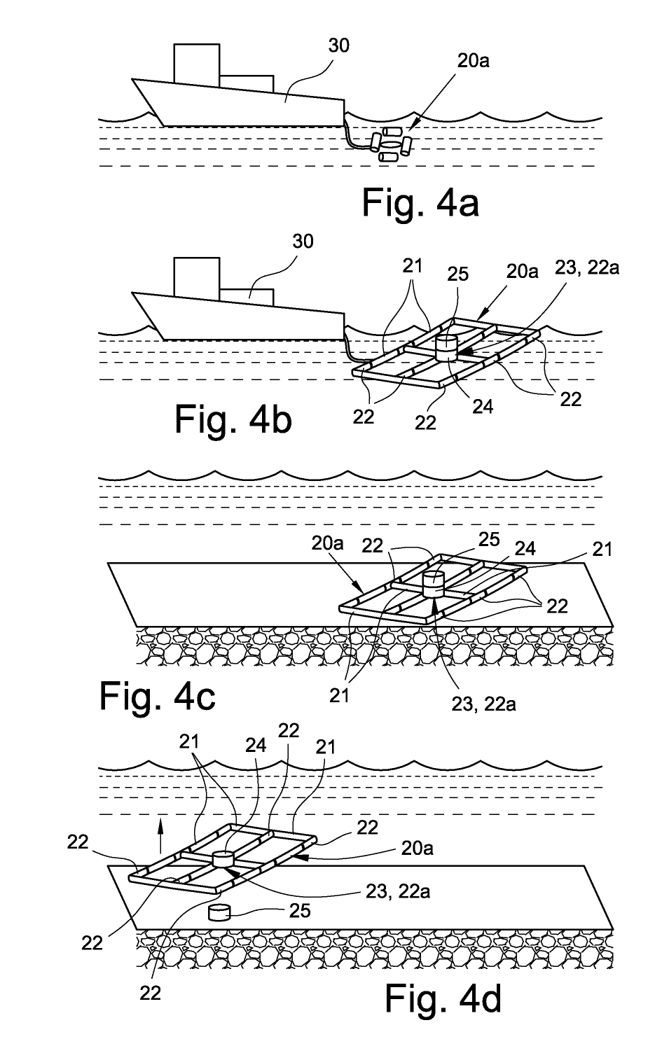

FIGS. 4a-4d are schematic views of a first embodiment of an electromagnetic reception device used in the detection system of underwater geological formations of FIG. 1 in the phases relating to release from the boat, deposition on the sea bottom, survey and recovery;

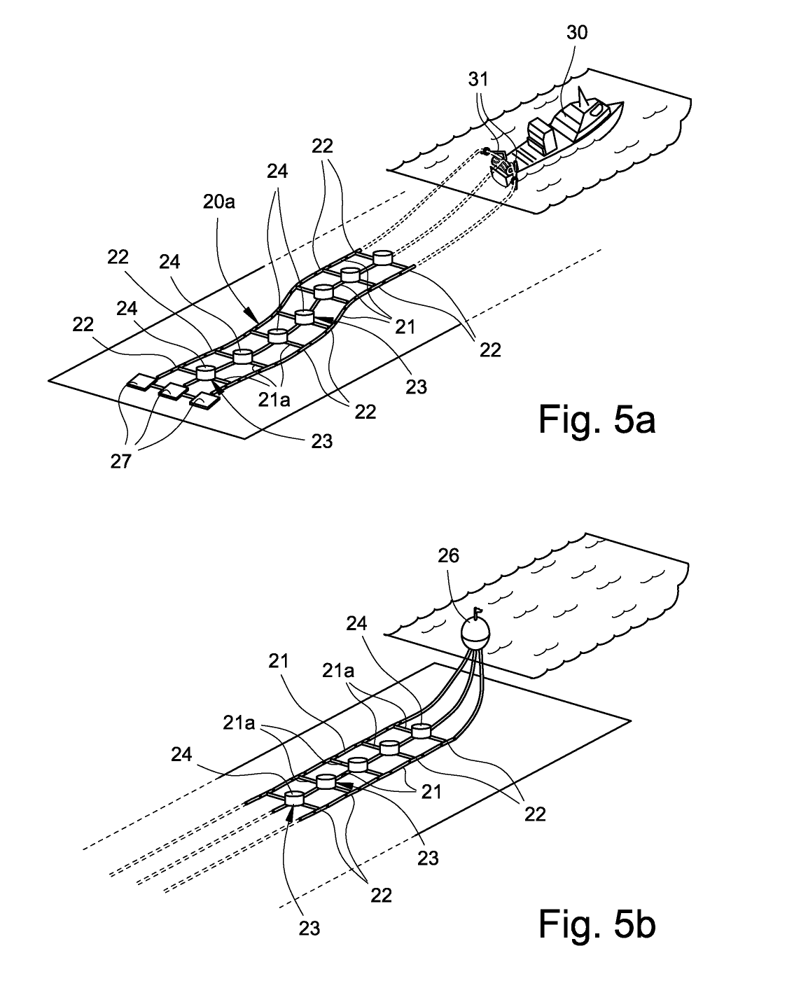

FIGS. 5a-5b are schematic views of a second embodiment of an electromagnetic reception device used in a detection system of underwater geological formations according to the present invention in the phases relating to release from the boat and survey.

With reference to the figures, these show a detection system of underwater geological formations, indicates as a whole with 100.

The detection system of underwater geological formations 100 comprises an electromagnetic transmission device 10 which can be moved within an area to be surveyed 101 through sea surface tow means 14 along at least one advance direction A and at least one electromagnetic reception device 20 positioned in the area to be surveyed 101, preferably an arrangement having a substantially linear development.

The arrangement of the electromagnetic reception device 20 is preferably parallel to the advance direction A, but can also be sloping with respect to the same by a known angulation.

According to a preferred embodiment illustrated, the electromagnetic transmission device 10 comprises at least three transmission electrodes 11,12,13 each connected to the surface tow means 14 through the interpositioning of depth stabilization means 15, such as for example a passive depressor or equipped with hydrodynamic flaps (not shown) capable of accentuating the downward thrust force exerted by the same 15 in order to regulate the navigation height of the transmission electrodes 11,12,13 with respect to the sea bottom.

Each transmission electrode 11,12,13 is associated with a piloting means 16, in the specific field known as “fish”, capable of correcting its relative positioning with respect to the at least one further electrode 11,12,13.

In particular, the transmission electrodes 11,12,13 are each contained or connected to a specific piloting means 16.

The piloting means 16 are capable of maintaining, through a plurality of flaps 16a, a first pair of transmission electrodes 11, 12 aligned, preferably along the advance direction A followed by the tow means 14, and a second pair of transmission electrodes 11, 13 aligned along a sloping direction with respect to the alignment direction of the first pair of transmission electrodes 11, 12.

Said piloting means 16 also allow the distance between the pairs of transmission electrodes 11,12,13 to be regulated, and consequently the length of the dipoles defined by them.

In this way, by feeding the transmission electrodes 11,12,13, at least two hertzian dipoles not parallel to each other, are generated.

The second pair of transmission electrodes 11, 13 is preferably kept aligned along a direction orthogonal to the alignment direction of the first pair of transmission electrodes 11, 12.

In order to maintain a precise relative positioning between pairs of transmission electrodes 11,12,13, the electromagnetic transmission device 10 comprises an acoustic system (not illustrated) for measuring the relative positioning between the single transmission electrodes 11,12,13.

The three transmission electrodes 11,12,13 are preferably arranged on a horizontal plane with respect to the sea surface or, alternatively, on a sloping plane.

The transmission electrodes 11,12,13 are connected to the surface tow means 14 by means of umbilical cables 17 suitable for transmitting the pulling force and also for transmitting data and the feeding.

According to the present invention, the piloting means 16 comprise a plurality of flaps 16a, a plurality of actuators 16b and variable ballast means 16c suitable for piloting a substantially vertical descent of the piloting means 16 during the stoppage phase on the sea bottom, i.e. during the transition between a dynamic entrainment condition shown in FIG. 2a, and a static laying condition on the sea bottom illustrated in FIG. 2b. In this way, the relative positioning between pairs of electrodes is controlled.

Furthermore, the electromagnetic transmission device 10 is advantageously equipped with floating means 18 suitable for allowing the cables 17 to push and consequently prevent them from becoming grounded during the static laying condition on the sea bottom.

The actuators are also capable of favouring the reciprocal positioning of the transmission electrodes 11,12,13 also during the inverse transient phase, i.e. passing from the static laying condition on the sea bottom to the dynamic entrainment condition.

According to alternative embodiments, the electromagnetic transmission device 10 also comprises a magnetic induction source (not illustrated) which can be positioned on the sea bottom during the static phase and can be used alternatively or in addition to the electric dipoles.

According to the present invention, the electromagnetic reception device 20 comprises at least one flat structure 20a consisting of a plurality of linear elements 21 constrained to each other according to a two-dimensional lattice configuration.

A reception electrode 22,22a is constrained in correspondence with a plurality of intersections between pairs of linear elements 21, also called nodes.

In the preferred embodiment illustrated, nine reception electrodes 22, 22a, are constrained to the flat lattice structure 20a, of which eight electrodes are positioned in correspondence with peripheral nodes and one electrode is positioned in correspondence with a central node 23; for the purposes of the present description, the reception electrodes 22, 22a are therefore respectively called peripheral reception electrodes 22 and central reception electrode 22a.

The flat lattice structure 20a, constrained to the same 20a, comprises, preferably in correspondence with the central node 23, a pressure-tight container 24 in which feeding and processing means (not illustrated) are situated, necessary for revealing measurements, such as for example a feeding unit, a memory unit, electronic processing means and so forth.

The dipoles formed by the peripheral reception electrodes 22 and the central reception electrode 22a are each connected to a differential amplifier (not illustrated) included in the processing means constrained in correspondence with the central node 23, which acquires a differential voltage between the two peripheral reception electrodes 22 and the central electrode 22a.

The difference in voltage between two generic electrodes 22 is obtained by combining the reading of, at the most, two differential amplifiers. The acquisition of the surveys of the eight differential amplifiers therefore allows the voltages of all the dipole configurations produced by the nine reception electrodes 22, 22a, to be obtained.

In particular, in the preferred embodiment illustrated, twelve dipole configurations can be obtained, which differ in length and/or orientation.

According to an alternative embodiment, a single differential amplifier can be used, whose inputs are alternatively connected to any pair of electrodes 22 and 22a.

This solution, however, only allows the surveys of single dipoles to be performed in sequence.

According to a preferred embodiment, the flat lattice structure 20a comprises at least one supplementary linear element (not illustrated) positioned orthogonally to the plane of the lattice structure 20a, at whose free end an additional reception electrode is constrained. In this way, a measurement of the vertical electric field can be additionally effected, obtaining data sufficient for reconstructing the complete tensor of the electric field generated in response by the marine subsoil.

According to a further preferred embodiment, at least one magnetometer (not illustrated) for the measurement of the magnetic field, is associated with the flat lattice structure 20a.

The linear elements 21 of the flat lattice structure 20a are preferably of the semi-rigid inflatable type so as to have a first compact configuration during transportation on a boat 30 and a second expanded configuration only once they have been released into the sea and/or have reached the sea bottom, as shown by the sequence of FIGS. 3a-3c.

In particular, the linear elements 21 are bellows pipes that can be filled with seawater or air at a pressure higher than that of the sea bottom.

This ensures that the flat lattice structure 20a maintains a semi-rigid configuration with regular spacing between the single reception electrodes 22, 22a.

Alternatively, the semi-rigid elements 21 of the grid structure can be produced by means of telescopic bars or expandable hinges.

The flat lattice structure 20a is preferably equipped with a plurality of hydrodynamic flaps (not illustrated) suitable for maintaining the expanded configuration during the sinking movement.

The flat lattice structure 20a is preferably of the floating type and comprises releasable ballast means 25, whose release can be remote-controlled, for example through an acoustic release system (not illustrated), for the recovery of the same 20a once the measurements have been terminated.

According to a particularly advantageous embodiment for use in less deep sea bottoms, the plurality of flat lattice structures 20a which compose the electromagnetic reception device 20 is produced in a single piece so as to form a lattice structure with a band conformation preferably consisting of three rows of longitudinal linear elements 21 kept parallel by transversal linear elements 21a and where a reception electrode 22 is constrained in correspondence with each intersection between the outer longitudinal linear elements 21 and the transversal linear elements 21a.

Two outer rows of peripheral reception electrodes 22 are therefore created together with a row of central nodes 23 interposed between the two outer rows.

A pressure-tight container 24 is constrained in correspondence with each of the central nodes 23 in which feeding and processing means (not illustrated) are present, preferably comprising at least three differential amplifiers for acquiring the difference in voltage between adjacent pairs of reception electrodes 22 along the same outer row or situated at the same height as separate outer rows.

Measurements relating to virtual dipoles having a greater length, i.e. defined between two non-adjacent reception electrodes 22 situated along the same outer row, are obtained by the sum of the differential voltages measured by two or more differential amplifiers.

Analogously, measurements relating to transversal dipoles can also be obtained.

As shown in FIG. 5a, the flat lattice structure 20a with a band conformation is preferably laid with the help of a boat 30 on which distancing means 31 are present, which are suitable for keeping the two outer rows of longitudinal linear elements 21 in tension during the laying, and guaranteeing the distance between the outer rows of longitudinal linear elements 21 in the case of flexible transversal elements. In the latter case, the weight of the flat lattice structure 20a itself ensures that the configuration is maintained on the sea bottom.

The flat lattice structure 20a having a band conformation, preferably comprises, at a first end with respect to the development of the band, a releasable anchor 27 for fixing to the sea bottom during the laying, and, at a second end with respect to said development, a surface buoy 26 suitable for facilitating the recovery of the structure 20a once the measurements have been terminated.

Various flat lattice structures 20a having a band conformation, or various combinations of single flat lattice structures 20a, can be laid on the sea bottom along parallel directions suitably distanced for covering a vaster area to be surveyed 101.

The functioning of the detection system 100 of underwater geological formations is the following.

Once the electromagnetic reception device 20 has been laid in the area to be surveyed 101 of the sea bottom, the electromagnetic transmission device 10 advances within this area to be surveyed 101, along at least an advance direction A aligned with respect to the main development of the arrangement of the electromagnetic reception device 20.

In the case of a flat lattice structure 20a having a band conformation, the electromagnetic transmission device 10 proceeds along a direction angularly known with respect to the development of the same 20a.

In the case of a plurality of single structures 20a, the electromagnetic transmission device 10 proceeds along a direction aligned with the arrangement of the combination of the single flat lattice structures 20a.

In particular, the electromagnetic transmission device 10 emits an electromagnetic signal generated by two hertzian dipoles not parallel with each other, as it proceeds along a route substantially parallel with respect to the position of the electromagnetic reception device 20.

Preferably, but not exclusively, the electromagnetic transmission device 10 proceeds along a parallel route and at an elevation ranging from 30 m to 60 m above the electromagnetic reception device 20, so that the measurements revealed mainly comprise an electromagnetic signal component given by the response from the subsoil.

Thanks to the particular electromagnetic transmission device 10 used in the system 100 for detecting underwater geological formations according to the present invention, the emission of the electromagnetic signal can also take place under stationary conditions. Once an area of particular interest has been identified, the electromagnetic transmission device 10 is guided towards the sea bottom maintaining the electrodes 11,12,13 in position so as not to modify the configuration of the dipoles.

For this purpose, the tow means 14 are first stopped so that the hydrodynamic forces exerted on the umbilical cables 17 diminish and the depth stabilization means 15 begin their descent towards the sea bottom.

By moving the umbilical cable 17, for example using a winch present on the tow means 14, the depth stabilization means 15 are maintained at a few meters from the sea bottom beneath the vertical of the tow means 14.

During the entrainment of the piloting means 16 on the part of the depth stabilization means 15, the relative variable ballast means 16c are progressively filled with seawater.

Once the velocity of the depth stabilization means 15 has dropped below a certain threshold, so as to bring the interconnections between single piloting means 16 into a tensionless configuration, the descent of these piloting means 16 towards the seabed is determined by the hydrodynamic resistance forces deriving from their residual motion.

The descent of the piloting means 16 is piloted, through the flaps 16a and actuators 16b, substantially vertically so as to maintain a certain orientation of the dipoles generated by the electrodes 11,12,13.

At the end of the descent, when the interconnections between single piloting means 16 are again under tension due to the action of the floating means 18 and sea current, said piloting means 16 are already in a rest configuration on the seabed and with the respective variable ballast means 16c filled so as to be able to oppose side forces due to the currents.

During its lay-up on the sea bottom, the electromagnetic transmission device 10 preferably emits electromagnetic signals, varying the frequency of the signals emitted, with time.

In this way, it is possible to detect the response of the marine subsoil also with respect to signals at different frequencies.

Furthermore, the particular arrangement of the transmission electrodes 11,12,13 allows two independent signals to be generated, which are in two independent measurements that can be effected by the electromagnetic reception device 20 used for detecting the response provided by the marine subsoil.

This device 20 allows measurements to be effected at a plurality of different angles and distances thanks to the use of the flat lattice structure 20a having a reception electrode 22, 22a in correspondence with substantially each node.

In particular, the possibility of effecting measurements at different distances allows the gradient of the electric field of the response of the subsoil to be obtained, which by its very nature, is linked to the resistivity of the means through the electric field emitted.

Furthermore, in the presence of the supplementary linear element positioned orthogonally to the plane of the lattice structure 20a and at whose end there is an additional electrode, it is also possible to effect measurements of the vertical component of the electric field. It is therefore possible to obtain a complete measurement of the tensor of the electric field.

In addition, if one or more magnetometers are associated with the lattice structure 20a, the electromagnetic reception device 20 is capable of also effecting the measurement of the magnetic response of the marine subsoil in the area to be surveyed 101. It is thus possible to obtain a complete measurement of the electromagnetic field tensor, including the natural electromagnetic field, called magnetotelluric, in addition to that produced by the controlled electromagnetic transmission device 10.

The characteristics of the system for detecting underwater geological formations, object of the present invention, are clear from the above description, as also the relative advantages.

Through the combination of two independent signals, which can be transmitted either in dynamic mode or in stationary mode, and the possibility of measuring in reception the complete tensor of the electromagnetic field supplied in response from the marine subsoil, it is possible to obtain measurements characterized by a high redundancy which allow stable and robust models of the configuration of the subsoil to be obtained.

These models are in fact univocally invertible, allowing the variation in the resistivity of the subsoil to be reconstructed with a high reliability.

Thanks to the possibility of obtaining data relating to the complete tensor, it is also possible to detect anisotropies and three-dimensional effects, with high precision.

Furthermore, the particular configuration of the electromagnetic transmission and reception devices allows a precise repositioning on the sea bottom, consequently offering the possibility of also effecting measurements which can be repeated with time. In this way, it is possible to monitor the evolution with time, of a hydrocarbon formation in terms of variations in the saturation of the fluids.

In addition, the possibility of piloting the electromagnetic transmission device resting on the sea bottom allows the energy reflection on the part of the sea bottom to be reduced, gaining depth of penetration of the electromagnetic energy irradiated.

Finally, the device thus conceived can obviously undergo numerous modifications and variants, all included in the invention; furthermore all the details can be substituted with technically equivalent elements. In practice, the material used, as also the dimensions, can vary according to technical requirements.

1. A system for detecting underwater geological formations comprising an electromagnetic transmission device which can be moved within an area to be surveyed through sea surface tow means along an advance direction (A) and at least one electromagnetic reception device positioned in said area to be surveyed characterized in that said electromagnetic reception device comprises at least one flat structure consisting of a plurality of linear elements constrained to each other according to a bidimensional lattice configuration and a plurality of reception electrodes, wherein each reception electrode, of said plurality of reception electrodes is constrained in correspondence with an intersection between pairs of said linear elements.

2. The system for detecting underwater geological formations according to claim 1, characterized in that said at least one flat lattice structure comprises a plurality of peripheral reception electrodes and at least one central reception electrode, processing means suitable for acquiring a differential voltage between at least one peripheral reception electrode of said plurality of peripheral reception electrodes and said at least one central reception electrode, being connected to said peripheral and central reception electrodes.

3. The system for detecting underwater geological formations according to claim 2, characterized in that said linear elements are of the semi-rigid inflatable type so as to have a first compact configuration and a second expanded configuration.

4. The system for detecting underwater geological formations according to claim 3, characterized in that said linear elements are fillable bellows pipes.

5. The system for detecting underwater geological formations according to any of the previous claims, characterized in that said at least one flat lattice structure is of the floating type, comprising releasable ballast means.

7. The system for detecting underwater geological formations according to claim 1, characterized in that said at least one flat lattice structure has a band conformation comprising at least two rows of longitudinal linear elements maintained parallel by transversal linear elements, a reception electrode of said plurality of reception electrodes being constrained in correspondence with a plurality of intersections between said longitudinal linear elements and said transversal linear elements, processing means suitable for acquiring a differential voltage between said pair of reception electrodes being connected to at least one pair of reception electrodes.

7. The system for detecting underwater geological formations according to claim 6, characterized in that said at least one flat lattice structure with a band conformation comprises, at a first end with respect to the development of said band, a releasable anchor for fixing to the sea bottom.

8. The system for detecting underwater geological formations according to claim 6, characterized in that said at least one flat lattice structure with a band conformation comprises, at a second end with respect to the development of said band, a surface buoy.

9. The system for detecting underwater geological formations according to claim 1, characterized in that said at least one flat lattice structure comprises at least one supplementary linear element positioned orthogonally to the plane of said flat lattice structure, an additional reception electrode being constrained to the free end of said supplementary linear element.

10. The system for detecting underwater geological formations according to claim 1, characterized in that at least one magnetometer is associated with said at least one flat lattice structure.

11. The system for detecting underwater geological formations according to claim 1, characterized in that said electromagnetic transmission device comprises at least three transmission electrodes, each of said transmission electrodes being associated with a piloting means suitable for adjusting the relative position of said transmission electrode with respect to at least a further transmission electrode.

12. The system for detecting underwater geological formations according to claim 11, characterized in that said piloting means are suitable for maintaining a first pair of transmission electrodes aligned along said advance direction (A), and a second pair of transmission electrodes aligned along a sloping direction with respect to said advance direction (A).

13. The system for detecting underwater geological formations according to claim 12, characterized in that said piloting means are suitable for maintaining a first pair of transmission electrodes aligned along said advance direction (A), and a second pair of transmission electrodes aligned along an orthogonal direction with respect to said advance direction (A).

14. The system for detecting underwater geological formations according to claim 11, characterized in that said electromagnetic transmission device comprises an acoustic system for measuring the relative position between said transmission electrodes.

15. The system for detecting underwater geological formations according to claim 11, characterized in that said piloting means comprise a plurality of flaps, actuators and variable ballast means suitable for piloting the entraining and stoppage of said piloting means on the sea bottom maintaining the relative positioning between pairs of transmission electrodes.

16. The system for detecting underwater geological formations according to claim 11, characterized in that each of said transmission electrodes is connected to said sea surface tow means through the interposition of depth stabilization means.

17. The system for detecting underwater geological formations according to claim 16, characterized in that said depth stabilization means are equipped with hydrodynamic flaps.

18. The system for detecting underwater geological formations according to claim 16, characterized in that each of said transmission electrodes is connected to said sea surface tow means by means of umbilical cables suitable for transmitting a pulling force exerted by said tow means and/or data and/or the feeding.

19. The system for detecting underwater geological formations according to claim 11, characterized in that said electromagnetic transmission device is equipped with floating means suitable for forcing said umbilical cables to push during a static laying position on the sea bottom.

20. The system for detecting underwater geological formations according to claim 11, characterized in that said electromagnetic transmission device also comprises a magnetic induction source.
